(19) United States
(12) Patent Application Publication
(10) Pub. No.: US 2026/0087658 A1
(43) Pub. Date: Mar. 26, 2026

(54) CALIBRATING A MONOCULAR DEPTH MAP BASED ON A THREE-DIMENSIONAL (3D) MODEL

(71) Applicant: Hover Inc., San Francisco, CA (US)

(72) Inventor: Yuzhong Huang, Los Angeles, CA (US)

(73) Assignee: Hover Inc., San Francisco, CA (US)

(21) Appl. No.: 19/338,301

(22) Filed: Sep. 24, 2025

Related U.S. Application Data
(60) Provisional application No. 63/699,046, filed on Sep. 25, 2024.

(51) Int. Cl. G06T 7/55

(52) U.S. Cl. CPC G06T 7/55; G06T 2207/10028

(57) ABSTRACT

An example provides a method, including: receiving a real-world two-dimensional (2D) image of a scene; obtaining, using a set of one or more processors, a depth map for the real-world 2D image, the depth map being selectively corrected using a second depth map formed using a three-dimensional (3-D) model of the scene; and creating, using the set of one or more processors, a representation of the scene based on the depth map selectively corrected by the 3-D model.

### CROSS-REFERENCE TO RELATED APPLICATIONS

This application claims priority to U.S. provisional patent application Ser. No. 63/699,046, filed Sep. 25, 2024, and having the title “Methods, Storage Media, and Systems for Calibrating Monocular Depth Map Based on a Three-Dimensional Model,” the entire contents of which are incorporated by reference herein.

### TECHNICAL FIELD

The disclosed implementations generally relate to the technical field of computer vision, and more specifically to depth maps.

### BACKGROUND

Depth estimation in computer vision has many applications including three dimensional (3D) visualization, 3D modeling, and the like. As a non-limiting example, a user may capture two-dimensional (2D) images of a building's interior or exterior using a single camera that is repositioned as the user walks around to capture the 2D images. These 2D images may be transformed into a 3D representation of the scene, allowing for a virtual scene to be constructed and viewed. Such virtual scenes may be used, for example, to provide virtual tours or walkthroughs of a building in an augmented reality display.

Monocular depth estimation is a technique that provides depth information from a single 2D image, facilitating building of a 3D scene. For example, in monocular depth estimation, each pixel of a 2D image is assigned a 3D depth to create a depth map. This can be done, for example, using a machine learning model that is trained to assign depths to the pixels of the 2D image. This depth information permits each 2D image to be converted into a 3D representation of the imaged scene. As such, monocular depth estimation has a potential for widespread use in scenarios where more sophisticated equipment (e.g., stereo or active depth sensing technology) is not feasible or desired. Examples of such scenarios include but are not limited to using a single camera, for example using one camera of a smartphone, to collect 2D images from varying points of view, such as when a user walks through a building taking pictures of the interior.

### SUMMARY

Existing monocular depth estimation techniques face several challenges that can lead to inconsistencies and inaccuracies in resulting depth estimates. In some instances, it may be difficult for monocular depth estimators, such as machine learning models, to predict accurate absolute depth estimates even when relative depths are accurately predicted. Such limitations may stem from data used to train the monocular depth estimators.

In some embodiments, a problem encountered in monocular depth estimation, for example that of an image depth map having inconsistencies and/or inaccuracies, is solved by selectively correcting a depth map of the image based on correspondences between the image and a 3D model. In some embodiments, selectively correcting may be through calibration of the depth map with corresponding depth information of the 3D model. This approach may improve the monocular depth estimation by leveraging the 3D model as a reference. The 3D model may be used to correct or fill in (i.e., replace) locations (e.g., depth values) of the depth map.

In summary, an embodiment provides a method, comprising: receiving, from a sensor, a real-world two-dimensional (2D) image of a scene; obtaining, using a set of one or more processors, a depth map for the real-world 2D image, the depth map being selectively corrected using a second depth map formed using a three-dimensional (3-D) model of the scene; and creating, using the set of one or more processors, a representation of the scene based on the depth map selectively corrected by the 3-D model.

In an embodiment the second depth map is generated using a second 2D image generated using a virtual camera pose and view of the 3-D model from the virtual camera pose. In an embodiment, the second depth map is generated from a virtual camera pose relative to a 3-D model generated from a light detection and ranging (LiDAR) scan.

In an embodiment, the 2D image comprises different regions identified using a segmentation process. In an embodiment, a method comprises labeling one or more of the different regions with one or more semantic labels. In an embodiment, the one or more different regions comprise one or more of a floor, a wall, and a ceiling. In an embodiment, a method comprises matching the one or more of the different regions with corresponding regions of the 3-D model.

In an embodiment, one or more depth values of corresponding regions in the 3-D model matched to the one or more different regions of the 2D image are used to selectively correct one or more depth values of the depth map.

In an embodiment, the more or more selectively corrected depth values of the depth map belong to a non-corresponding region of the 2D image. In this way, objects that may be depicted as part of the scene in the 2D image, but are not modeled in the 3-D model, may have their depth values updated even though they have no corresponding semantic region in the 3-D model. Correction or calibration depth values of a 3-D model are more reliable, they vary smoothly and continuously across local regions. Therefore, correction or calibration depth values of these reliable regions (such as floors, ceilings, or walls) can be used to update corresponding regions in an associated 2D image, and corrections or calibrations applied to such corresponding regions can be extended to other regions of the 2D image even if such region is not part of the modeled geometry of the 3-D model.

In an embodiment, the depth map is selectively corrected based on a depth value having a position in the 2D image proximate to a position of a depth value in the corresponding 3-D model. In this way, depth values of the second depth map are selected for correcting or calibrating the depth map when their position is near the corresponding value of the 2D image. In an embodiment, near positions are based on Euclidean distance; in an embodiment, near positions are based on a distance orthogonal to an optical axis for a camera associated with the depth map.

In an embodiment, the selectively correcting comprises one or more of replacing and modifying depth information of pixels of the real-world 2D image using depth information of the second depth map.

In an embodiment, the obtaining comprises requesting the depth map for the real-world 2D image from a model trained to generate depth maps. In an embodiment, the model is trained using a plurality of depth maps corrected by an associated three-dimensional (3-D) model.

In an embodiment, the representation of the scene comprises 3D virtual imagery formatted for augmented reality (AR) or virtual reality (VR) display.

In another aspect, a computer system includes one or more processors, non-transitory computer readable storage medium, and one or more programs stored in the non-transitory computer readable storage medium. The one or more programs are configured for execution by the one or more processors. The one or more programs include instructions for performing any of the methods, or parts thereof, as described herein.

In another aspect, a non-transitory computer readable storage medium stores one or more programs configured for execution by one or more processors of a computer system. The programs include instructions for performing any of the methods, or parts thereof, as described herein.

The foregoing is a summary and is not intended to be in any way limiting. For a better understanding of the example embodiments, reference can be made to the detailed description and the drawings. The scope of the invention is defined by the claims.

### BRIEF DESCRIPTION OF THE DRAWINGS

FIG. 1 is a schematic diagram of a computing system in accordance with some embodiments.

FIG. 2 is an example method in accordance with some embodiments.

FIG. 3A and FIG. 3B are illustrations of example two-dimensional (2D) images, camera poses, and a three-dimensional (3D) model according to some embodiments.

FIG. 4 illustrates an example method according to an embodiment.

### DETAILED DESCRIPTION

Reference will now be made to various embodiments, examples of which are illustrated in the accompanying drawings. In the following detailed description, numerous specific details are set forth to provide a thorough understanding of the embodiments and the described implementations. However, the claims may be practiced without these specific details or in alternate sequences or combinations. In other instances, well-known methods, procedures, components, and circuits have not been described in detail so as not to unnecessarily obscure aspects of the embodiments.

An embodiment is directed to selectively correcting, or in some embodiments calibrating, a monocular depth estimate for a real-world 2D image. In an embodiment, a monocular depth estimate provides a first depth map. A depth map is image information relating to the distance of object(s) in the scene, depicted as pixels, captured by the 2D image. The first depth map may include an estimate of a plurality of first locations relative to the camera pose associated with the 2D image. The plurality of first locations may be a plurality of depth values, where each depth value represents an estimate of where in 3D space a corresponding pixel of the 2D image is relative to the camera pose. In some embodiments, the first depth map may be generated by a monocular depth estimator model. Examples of monocular depth estimator models include Metric3D, Depth Anything, ZoeDepth, and the like.

Monocular depth estimator models may face several challenges that can lead to inconsistencies and inaccuracies in resulting depth estimates that require selective correction or calibration by an embodiment. For example, existing depth estimator models may provide inaccurate absolute depth estimates even when relative depths are accurately predicted. This limitation may stem from data used to train the monocular depth estimators. In some cases, monocular depth estimators may predict inaccurate depth estimates or no depth estimates when an image lacks clear depth cues. This may occur in scenes with uniform textures, similar textures, featureless textures, dark textures, reflective textures, occlusions between an imager, foreground elements, and background elements, and the like. In some cases, biases in data that is used to train monocular depth estimator models can lead to systematic errors in depth estimation. For instance, monocular depth estimator models trained primarily on outdoor scenes with ample lighting and distant objects may struggle to accurately predict depths in indoor environments or scenes with similar lighting and closer objects. These biases can result in overestimation of distances in certain scenarios, limiting the versatility and reliability of the depth estimation system.

Accordingly, an embodiment obtains a selectively corrected or calibrated depth map for a real-world 2D image. In an example embodiment, a 3D model of a known scene or scene type, such as a computer aided design (CAD) model of an interior room of a house or the exterior of the house or a 3D model created from light detection and ranging (LiDAR), is used to selectively correct or generate a calibrated depth map for a real-world 2D image associated with the 3D model. In an embodiment, obtaining selective corrections to or generating a calibration for a depth map includes modifying a first depth map estimated by existing depth estimator models using a 3D model provided second depth map. That is, in an embodiment a 3D model provides a second depth map from a viewpoint that is used to calibrate or correct the first depth map estimated for the real world 2D image using the same viewpoint. The viewpoint of the 2D image and the viewpoint of the 3D model are aligned to be the same, such as by matching the geometric coordinates of each, which may include transforming from one coordinate system (e.g., a CAD system) to another (e.g., those used by the camera device), matching the pose of the camera associated with the 2D image with a virtual camera associated with the 3D model, or matching intrinsics of the camera associated with the 2D image with a virtual camera associated with the 3D model. In an embodiment, the depth map information from the existing depth estimator model is calibrated or corrected, e.g., replaced by, the depth map information from the 3D model.

In an embodiment, the 3D model offers information that is most useful when matched to image features, for example using a segmentation process. In an embodiment, depth information based on the 3D model is useful for certain scene features that can be matched to the real-world 2D image reliably, such as a wall, ceiling, or floor, and consequently only these subregions or subsets of the scene are calibrated or corrected in the first depth map of the real-world 2D image. These regions may be referred to as calibration reference regions. Where semantic labels are added (e.g., floor, wall, etc.) the regions may be referred to as semantic calibration reference regions.

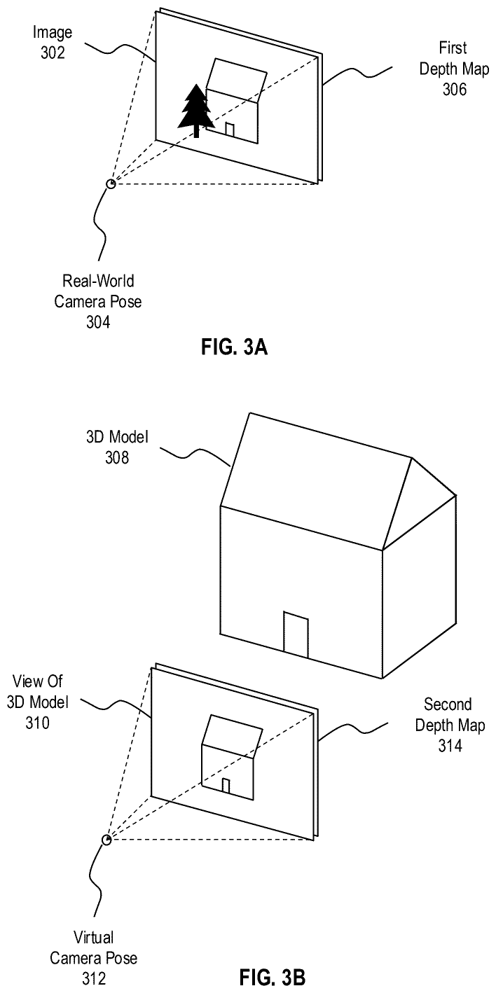

In an embodiment, calibration reference regions may be used to calibrate or correct unmatched reasons. Referring briefly to FIGS. 3A-3B, an occluding object (a tree) is captured in image 302. A corresponding model of the house in image 302 is depicted as 3D model 308. The occluding object has no corresponding depth values in 3D model 308, but is proximate to a calibration reference region (a side portion of the house is illustrated as a front façade of the house in image 302 and is modeled in 3D model 308). Corrected or calibrated depth values of the calibration reference region (the front façade) near the occluding object may be used to correct or calibrate the depth values of the first depth map 306 associated with the occluding object.

In an embodiment, depth values in a calibration reference region within a Euclidean distance from one or more pixels of the occluding object are used to calibrate or correct the depth values of the occluding object. In an embodiment, depth values in a calibration reference region relative to one or more pixels of the occluding object in a direction orthogonal to an optical axis of real world camera pose 304 are used to calibrate or correct the depth values of the occluding object. In an embodiment, depth values in a calibration reference region bordering the pixels of the occluding object are used to calibrate or correct the depth values of the occluding object. In an embodiment, obtaining or generating a corrected or calibrated depth map may include using a depth map generated from a 3D model to train a depth estimator model. For example, synthetic images produced using a 3D model, for example of a room interior, may be used to train a depth estimator model that is later supplied real-world 2D images to generate depth maps.

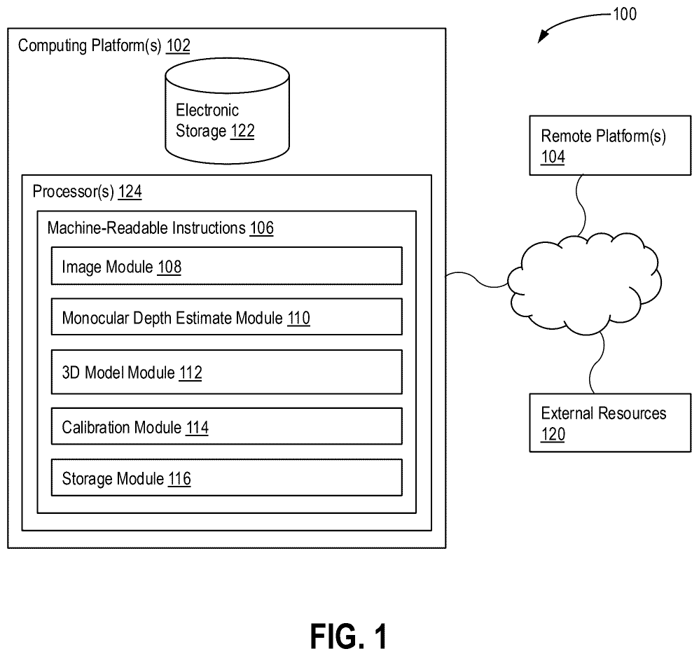

FIG. 1 illustrates an example system 100 configured for correcting or calibrating a monocular depth estimate based on a 3D model, in accordance with one or more embodiments. In some embodiments, system 100 may include one or more computing platforms 102. One or more computing platforms 102 may be configured to communicate with remote platform(s) 104 according to a client/server architecture, a peer-to-peer architecture, and/or other architectures. Remote platform(s) 104 may be configured to communicate with other remote platforms via one or more computing platforms 102 and/or according to a client/server architecture, a peer-to-peer architecture, and/or other architectures.

Users may access system 100 via remote platform(s) 104. One or more computing platforms 102 may be configured by machine-readable instructions 106. Machine-readable instructions 106 may include one or more instruction modules. The instruction modules may include computer program modules. The instruction modules may include one or more of image module 108, monocular depth estimate module 110, 3D model module 112, calibration module 114, storage module 116, and/or other instruction modules.

Image module 108 may be configured to provide, receive, capture, or otherwise obtain an image and an associated camera pose. In some embodiments, the image may be a real-world image, and the associated camera pose may be a real-world camera pose. In some embodiments, the image may be a synthetic or virtual image, and the associated camera pose may be a synthetic or virtual camera pose. In some embodiments, the image may be a 2D real-world image of a building structure, capturing details of one or more of the interior or exterior of the building structure. That is, in some embodiments, the image may include an interior of the building structure, an exterior of the building structure, or both.

Monocular depth estimate module 110 may be configured to provide, generate, or otherwise obtain a monocular depth estimate of the image provided by image module 108. In some embodiments, the monocular depth estimate may be of the scene, or portions thereof, in the image.

In an embodiment, 3D model module 112 may be configured to provide, receive, generate, or otherwise obtain a 3D model. In some embodiments, the 3D model may include a parametric model. In some embodiments, the 3D model may include a point cloud. In some embodiments, the 3D model may include a line cloud. In some embodiments, the 3D model may be generated based on a plurality of images. In some embodiments, the 3D model may be generated by LiDAR. In some embodiments, the plurality of images the 3D model is generated based on may include the image provided by image module 108. In some embodiments, the plurality of images the 3D model is generated based on may not include the image provided by image module 108. In some embodiments, the 3D model may be a 3D representation of the scene, or portions thereof, in the image.

Calibration module 114 may be configured to selectively correct or calibrate the first depth map based on correspondences between the image and a view of the 3D model from a virtual camera pose, where the virtual camera pose corresponds to the camera pose of the image. In some embodiments, one or more modules of system 100 may be configured to generate the view of the 3D model from the virtual camera pose. In some embodiments, the view of the 3D model from the virtual camera pose is represented as a 2D image.

In some embodiments, the 3D model may be considered to be a ground truth representation of the scene, or portion thereof, in the image, and therefore the view of the 3D model from the virtual camera pose may be considered to be a ground truth representation with respect to the first depth map. In such embodiments, inconsistencies and/or inaccuracies of the first depth may be corrected or calibrated based on the view of the 3D model.

In some embodiments, one or more module of system 100 may be configured to generate a second depth map of the view of the 3D model from the virtual camera pose. The second depth map may include a plurality of second locations relative to the virtual camera pose. The plurality of second locations may be a plurality of depth values, where each depth value represents where in 3D space a corresponding portion of the view of the 3D model is relative to the virtual camera pose. In embodiments where the view of the 3D model is a 2D image, the plurality of second locations may be a plurality of depth values, where each depth value represents where in 3D space a corresponding pixel of the 2D image is relative to the virtual camera pose.

In some embodiments, calibration module 114 may be configured to correct or calibrate the first depth map based on correspondences between the first depth map and the second depth map. In some embodiments, there may be one-to-one correspondences between the first depth map and the second depth map.

In some embodiments, each of the first depth map and the second depth map may be an N×M array where each entry of the array represents a depth value. Each entry of the array of the first depth map represents a predicted depth value according to a monocular depth estimate of the image and each entry of the array of the second depth map represents a depth value according to a view of the 3D model. In some embodiments, calibration module 114 may be configured to correlate one or more first locations of the plurality of first locations of the first depth map with one or more corresponding second locations of the plurality of second locations of the second depth map. In some embodiments, this correlating may include calibrating or updating such as replacing an entry of the array of the first depth value with a corresponding entry of the array of the second depth value.

In some embodiments, calibration module 114 may be configured to derive at least one scaling factor based on correspondences between the first depth map and the second depth map and apply the at least one scaling factor to one or more first locations of the plurality of first locations. In some embodiments, different portions of the first depth map may be scaled differently. For example, one portion of the first depth map may be scaled by a first amount and another portion of the of the first depth map may be scaled by a second amount. In some embodiments, calibration module 114 may be configured to derive the least one scaling factor based on pixel-wise differences between the first depth map and the second depth map. In some embodiments, computing the pixel-wise differences may include creating one or more scaling matrices, where each entry in a scaling matrix is computed based on a difference between a corresponding entry of the array of the second depth map and a corresponding entry of the array of the first depth map.

In some embodiments, calibration module 114 may be configured to derive at least one offset factor based on correspondences between the first depth map and the second depth map and apply the at least one offset factor to one or more first locations of the plurality of first locations. In some embodiments, different portions of the first depth map may be offset differently. For example, one portion of the first depth map may be offset in by a first amount in a first direction and another portion of the first depth map may be offset by a second amount in a second direction. In some embodiments, calibration module 114 may be configured to derive the least one offset factor based on pixel-wise differences between the first depth map and the second depth map. In some embodiments, computing the pixel-wise differences may include creating one or more offset matrices, where each entry in an offset matrix is computed based on a difference between a corresponding entry of the array of the second depth map and a corresponding entry of the array of the first depth map.

In some embodiments, one or more modules of system 100, for example image module 108, may be configured to segment the image into a plurality of regions. In some embodiments, segmenting the image may include semantically segmenting the image into a plurality of regions. In some embodiments, the 3D model may include a plurality of calibration reference regions. In some embodiments, the 3D model may include a plurality of semantically labeled calibration reference regions. In some embodiments, one or more modules of system 100, for example 3D model module 112, may be configured to label the 3D model into the plurality of calibration reference regions.

In some embodiments, the first depth map may include a corresponding plurality of regions as compared to those of the 3D model. The first depth map may include a plurality of first locations relative to the camera pose associated with the image. The plurality of first locations may be a plurality of depth values, where each depth value represents an estimate of where in 3D space a corresponding 2D pixel of the image is relative to the camera pose. In some embodiments, each depth value may be associated with a region of the plurality of regions. In some embodiments, the view of the 3D model may include the plurality of regions. In some embodiments, calibration module 114 may be configured to correct or calibrate the first depth based on correspondences between classes of the plurality of regions, for example using semantic labels. In other words, the plurality of regions of a real-world 2D image first depth map and a corresponding plurality of regions of a 3D model second depth map may be matched using semantic labels. Non-limiting examples of classes of regions for semantic labels include ground, floor, wall, roof, ceiling, window, opening, door, cabinet, and the like. One of ordinary skill in the art will appreciate that other classes and labels are within the scope of this disclosure.

By way of example, in an embodiment the image may include a bedroom. The image may be segmented into regions such as floor, wall, ceiling, and the like. The image may include other regions such as bed, dresser, nightstand, lamp, mirror, and the like. The 3D model may include regions such as floor, wall, ceiling, and the like. In some examples, the 3D model may not include other regions such as bed, dresser, nightstand, lamp, mirror, and the like. In other words, the other regions such as bed, dresser, nightstand, lamp, mirror, and the like may not be modeled and therefore may not be represented in the 3D model. The first depth map may include the regions. The regions of the image may be imparted from the image to the first depth map. The view of the 3D model may include corresponding regions. The first depth map may be corrected or calibrated further based on correspondences between classes of the regions of the first depth map and the regions of the view of the 3D model. For example, floor regions of the first depth map may be corrected or calibrated based corresponding floor regions of the view of the 3D model, wall regions of the first depth map may be corrected or calibrated based on corresponding wall regions of the view of the 3D model, ceiling regions of the first depth map may be corrected or calibrated based on corresponding ceiling regions of the view of the 3D model, and the like. In other words, the floor, wall, and ceiling regions of the view of the 3D model may be the reference for the correction or calibration of the floor, wall, and ceiling regions of the first depth map.

In an embodiment, other regions of the first depth map may be calibrated based on how the matched or calibration regions have been calibrated. For example, bed regions, dresser regions, nightstand regions, lamp regions, mirror regions, and the like, which are not matched to reference data based on the 3D model, may be calibrated based on how the matched regions, e.g., floor regions, wall regions, ceiling regions, and the like, are calibrated.

In some embodiments, one or more modules of system 100 may be configured to generate a second depth map of the view of the 3D model from the virtual camera pose. The second depth map may include a plurality of second locations relative to the virtual camera pose and the plurality of regions. The plurality of second locations may be a plurality of depth values, where each depth value represents where in 3D space a corresponding portion of the view of the 3D model is relative to the virtual camera pose. In embodiments where the view of the 3D model is a 2D image, the plurality of second locations may be a plurality of depth values, where each depth value represents where in 3D space a corresponding pixel of the 2D image is relative to the virtual camera pose. In some embodiments, each depth value may be associated with a region of the plurality of regions.

In some embodiments, calibration module 114 may be configured to correct or calibrate the first depth map based on correspondences between the plurality of regions of the first depth map and the plurality of regions of the second depth map. In some embodiments, there may be one-to-one correspondences between the first depth map and the second depth map. In some embodiments, calibration module 114 may be configured to correlate one or more first locations of the plurality of first locations of the first depth map with one or more corresponding second locations of the plurality of second locations of the second depth map based on the correspondences between regions. In some embodiments, this correlating may include calibrating or updating, such as by replacing an entry of an array of the first depth values with a corresponding entry of an array of the second depth values based on correspondences between the plurality of regions. In an embodiment, the updating may take a different form than replacement, such as averaging, applying a scaling factor, or applying an offset factor, which may be done per segment or region. In some embodiments, a combination of updating types may be performed, including not updating certain regions.

In some embodiments, calibration module 114 may be configured to derive at least one scaling factor based on correspondences between the plurality of regions of the first depth map and the plurality of regions of the second depth map and apply the at least one scaling factor to one or more first locations of the plurality of first locations of the first depth map. In some embodiments, different portions of the first depth map may be scaled differently. For example, one portion of the first depth map may be scaled by a first amount and another portion of the of the first depth map may be scaled by a second amount. In some embodiments, calibration module 114 may be configured to derive the least one scaling factor based on pixel-wise differences between the first depth map and the second depth map. In some embodiments, the pixel-wise differences may be based on correspondences between the plurality of regions, as described herein. In some embodiments, computing the pixel-wise differences may include creating one or more scaling matrices, where each entry in a scaling matrix is computed based on a difference between a corresponding entry of the array of the second depth map and a corresponding entry of the array of the first depth map.

In some embodiments, calibration module 114 may be configured to derive at least one offset factor based on correspondences between the plurality of regions of the first depth map and the plurality of regions of the second depth map and apply the at least one offset factor to one or more first locations of the plurality of first locations of the first depth map. In some embodiments, different portions of the first depth map may be offset differently. For example, one portion of the first depth map may be offset in by a first amount in a first direction and another portion of the first depth map may be offset by a second amount in a second direction. In some embodiments, calibration module 114 may be configured to derive the least one offset factor based on pixel-wise differences between the first depth map and the second depth map. In some embodiments, the pixel-wise differences may be based on correspondences between the plurality of regions, as described herein. In some embodiments, computing the pixel-wise differences may include creating one or more offset matrices, where each entry in an offset matrix is computed based on a difference between a corresponding entry of the array of the second depth map and a corresponding entry of the array of the first depth map.

In some embodiments, storage module 116 may be configured to store the corrected or calibrated first depth map. In some embodiments, one or more of the 2D image and the corrected or calibrated first depth map may be used for training a monocular depth estimator model, such as included in a set of labeled examples used for training data.

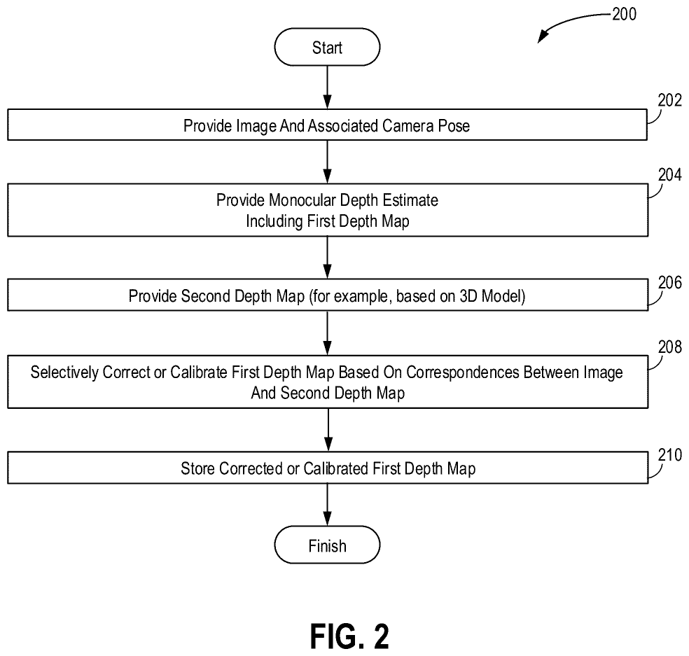

FIG. 2 illustrates a method 200 for correcting or calibrating a monocular depth estimate based on a 3D model, in accordance with one or more embodiments. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described is not intended to be limiting.

In some embodiments, method 200 or parts thereof may be implemented using one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include providing, receiving, capturing, or otherwise obtaining an image and an associated camera pose. This operation may be performed by an image module similar to or the same as image module 108. In some embodiments, the image may be a real-world 2D image and the associated camera pose may be a real-world camera pose. In some embodiments, the 2D image may be a synthetic or virtual image and the associated camera pose may be a synthetic or virtual camera pose. In some embodiments, the synthetic or virtual image may be generated by a model, such as a generative machine learning (GML) model. In some embodiments, the synthetic or virtual camera pose may be a camera pose of an image that was input to the model. In some embodiments, the synthetic or virtual camera pose may be a camera pose that is predicted based on the synthetic or virtual image. In some embodiments, the image may include a scene. In some embodiments, the image may include a building structure. In some embodiments, the image may include an interior of the building structure, an exterior of the building structure, or both.

An operation 204 may include providing, generating, or otherwise obtaining a monocular depth estimate of the 2D image provided by operation 202. This operation may be performed by a monocular depth estimate module similar to or the same as monocular depth estimate module 110, in accordance with one or more implementations. In some embodiments, the monocular depth estimate may be of the scene, or portions thereof, in the image, e.g., including an object such as a building exterior, building interior, or combinations thereof. The monocular depth estimate may include a first depth map. The first depth map may include a plurality of first locations relative to the camera pose associated with the 2D image. The plurality of first locations may be a plurality of depth values, where each depth value represents an estimate of where in 3D space a corresponding pixel of the 2D image is relative to the camera pose. In some embodiments, the monocular depth estimate may be generated by a model, such as a monocular depth estimator model.

An operation 206 may include providing, receiving, generating, or otherwise obtaining a 3D model. This operation may be performed by a 3D model module similar to or the same as 3D model module 112, in accordance with one or more implementations, e.g., the 3D model may be a 3D representation of the scene, or portions thereof, in the 2D image.

In some embodiments, method 200 may include generating the view of the 3D model from the virtual camera pose. In some embodiments, the view of the 3D model from the virtual camera pose is represented as a 2D image. In some embodiments, method 200 may include generating a second depth map according to the view of the 3D model from the virtual camera pose. The second depth map may include a plurality of second locations relative to the virtual camera pose. The plurality of second locations may be a plurality of depth values, where each depth value represents where in 3D space a corresponding portion of the view of the 3D model is relative to the virtual camera pose. In embodiments where the view of the 3D model is a 2D image, the plurality of second locations may be a plurality of depth values, where each depth value represents where in 3D space a corresponding pixel of the 2D image is relative to the virtual camera pose.

In some embodiments, the 3D model may be considered to be a ground truth representation of the scene, or portion thereof, in the image, and therefore the view of the 3D model from the virtual camera pose may be considered to be a ground truth representation with respect to the first depth map. Inconsistencies or inaccuracies of the first depth may be corrected or calibrated based on the view of the 3D model.

An operation 208 may include correcting or calibrating the first depth map based on correspondences between the image and a view of the 3D model from a virtual camera pose, where the virtual camera pose corresponds to the camera pose of the image. This operation may be performed by a calibration module similar to or the same as calibration module 114, in accordance with one or more implementations.

In some embodiments, operation 208 may include correcting or calibrating the first depth map based on correspondences between the first depth map and the second depth map. In some embodiments, there may be one-to-one correspondences between the first depth map and the second depth map.

In some embodiments, each of the first depth map and the second depth map may be an N×M array where each entry of the array represents a depth value. Each entry of the array of the first depth map represents a predicted depth value according to a monocular depth estimate of the image and each entry of the array of the second depth map represents a depth value according to a view of the 3D model. In some embodiments, operation 208 may include correlating one or more first locations of the plurality of first locations of the first depth map with one or more corresponding second locations of the plurality of second locations of the second depth map. In some embodiments, this correlating may include calibrating or updating, such as replacing an entry of the array of the first depth value with a corresponding entry of the array of the second depth value.

In some embodiments, operation 208 may include deriving at least one scaling factor and/or offset factor based on correspondences between the first depth map and the second depth map and applying the at least one scaling factor as described herein.

In some embodiments, one or more operations of method 200, for example operation 202, may include segmenting the image into a plurality of regions useful for calibration. In some embodiments, segmenting the image may include semantically segmenting the image into a plurality of semantic calibration regions that are matched using semantic labels or other metadata to regions of a real-world 2D image, as described herein.

An operation 210 may include storing the corrected or calibrated first depth map. This operation may be performed by a storage module similar to or the same as storage module 116, in accordance with one or more implementations. In some embodiments, the image and the corrected or calibrated first depth map may be used for training a monocular depth estimator model.

FIGS. 3A-3B illustrate correcting or calibrating a monocular depth estimate based on a 3D model, according to some embodiments. FIG. 3A illustrates 2D image 302 from associated real-world camera pose 304, according to some embodiments. In the illustrated example, 2D image 302 includes a view of imaged real-world objects, e.g., a tree and a side view of an exterior of a building structure. The side view of the building structure includes a side portion (e.g., front façade), a door, a roof portion, a floor, a ceiling, and a wall. Illustrated is first depth map 306 of a monocular depth estimate of 2D image 302, according to some embodiments. First depth map 306 may include a plurality of first locations relative to real-world camera pose 304 associated with 2D image 302. The plurality of first locations may be a plurality of depth values, where each depth value represents an estimate of where in 3D space a corresponding pixel of 2D image 302 is relative to real-world camera pose 304.

Also shown is a 3D model 308 and view of 3D model 310 from virtual camera pose 312, according to some embodiments. Virtual camera pose 312 corresponds to real-world camera pose 304, e.g., aligned using coordinate systems of respective sources such as a camera used to capture 2D image 302 and modeling system used to generate view of 3D model 310. In some embodiments, a virtual camera associated with virtual camera pose 312 and a real-world camera associated with real-world camera pose 304 may have similar or the same camera intrinsics, camera extrinsics, or both. In some embodiments, for example as illustrated, view of 3D model 310 is represented itself as a 2D image. First depth map 306 may be calibrated based on view of 3D model 310 from virtual camera pose 312.

FIG. 3B illustrates second depth map 314 of view of 3D model 310, according to some embodiments. Second depth map 314 may be generated based on a spatial relationship between view of 3D model 310, virtual camera pose 312, and 3D model 310. Second depth map 314 may include a plurality of second locations relative to virtual camera pose 312. The plurality of second locations may be a plurality of depth values, where each depth value represents where in 3D space a corresponding portion of view of the 3D model 310 is relative to virtual camera pose 312. In embodiments where view of 3D model 310 is a 2D image, the plurality of second locations may be a plurality of depth values, where each depth value represents where in 3D space a corresponding pixel of the 2D image is relative to virtual camera pose 312. First depth map 306 may be corrected or calibrated based on correspondences between first depth map 306 and second depth map 314.

For example, the monocular depth estimate of 2D image 302 may predict the side portion (the front façade) of the building structure is a first distance (e.g., two meters) from real-world camera pose 304 and these values may be represented in first depth map 306, however view of 3D model 310 may have the corresponding side portion of 3D model 308 at a second distance (e.g., two and a half meters) from virtual camera pose 312 and may be represented in second depth map 314. In this example, first depth map 306 may be corrected or calibrated based on second depth map 314, where the side portion having the first distance value (e.g., two meters) may be updated with the second distance value (e.g., two and a half meters). In this example, although neither 3D model 308, view of 3D model 310, nor second depth map 314 include depth information of a tree, depth values of first depth map 306 corresponding to the tree in image 302 may be corrected or calibrated based on how other portions of first depth map 306 are corrected or calibrated, e.g., offset or scaled by a like amount, as described throughout this disclosure.

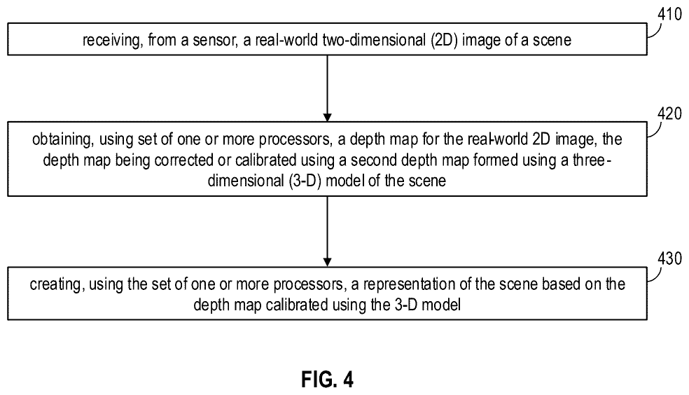

Referring to FIG. 4, an embodiment includes a method, comprising receiving, from a sensor, a real-world two-dimensional (2D) image of a scene, which may comprise an object, as indicated at 410. For example, a user may upload one or more 2D images using a mobile application, where the 2D images are real-world images of a building interior or exterior captured with a smartphone camera.

As illustrated in FIG. 4, in an embodiment a method includes obtaining, using set of one or more processors, a depth map for the real-world 2D image, the depth map being corrected or calibrated using a second depth map formed using a three-dimensional (3-D) model of the scene, as indicated at 420. For example, a cloud-based service to which the user's real-world 2D images are uploaded may process the photos to generate a depth map, or a local machine learning model may process the photos to generate a depth map on a device. In an embodiment, a corrected or calibrated depth map is obtained by producing a first depth map using a naïve model and then correcting or calibrating the first depth map based on a second depth map generated using additional 3D data, such as 3D model or LiDAR representation, as described herein. In an embodiment, the depth map is obtained in a calibrated form more directly, e.g., from a machine learning model that has been trained using images, corrected or calibrated depth maps, or related data from a 3D model of a matched scene, e.g., an interior room type, a building exterior type, etc.

In an embodiment, a method as illustrated in FIG. 4 may include creating, using the set of one or more processors, a representation of the scene based on the depth map corrected or calibrated using the 3-D model, indicated at 430. For example, one or more real-world 2D images may be used to obtain one or more corrected or calibrated depth maps as described in connection with the receiving and obtaining at 410 and 420, respectively. The one or more corrected or calibrated depth maps may be used to produce a set of 3D points or a 3D mesh. Pixels of respective 2D image(s) associated with the 3D point or 3D mesh may used to texture a virtual representation of the scene in a 3D manner. In an embodiment, this may take the form of 3D virtual imagery that is provided in the form of a virtual tour or walkthrough. For example, in an embodiment the representation of the scene comprises 3D virtual imagery formatted for augmented reality (AR) or virtual reality (VR) display or other 3D rendering service, and may be provided to a user on a display such as a smartphone, a virtual reality headset, or similar. This permits the user to view the 2D image data in a virtual 3D environment.

Therefore, in an embodiment the second depth map is generated using a second 2D image generated using a virtual camera pose and view of the 3-D model. In an embodiment, the obtaining comprises correcting or calibrating the depth map using the second depth map.

In an embodiment, the second depth map comprises different regions identified using a semantic labeling process. In an embodiment, a method such as illustrated in FIG. 4 comprises labeling one or more of the different regions with one or more semantic labels, e.g., as part of the obtaining illustrated at 420. In an embodiment, the one or more of the different regions are matched with similarly labeled regions of the real-world 2D image, such labeled regions of the 2D image may be obtained through semantic segmentation. In an embodiment, the one or more different regions comprise one or more of a floor, a wall, and a ceiling.

In an embodiment, the obtaining at 420 includes correcting or calibrating, in turn comprising one or more of replacing and modifying depth information of pixels of the real-world 2D image using depth information of the second depth map.

In an embodiment, the obtaining indicated at 420 comprises requesting the depth map for the real-world 2D image from a model trained to generate depth maps, wherein the model is trained using a plurality of depth maps corrected or calibrated using a three-dimensional (3-D) model, e.g., of the scene imaged or similar scenes.

In an embodiment, system 100 illustrated in FIG. 1 may generate and provide 3D representation of a scene to user devices, e.g., represented by one or more computing platforms 102. For example, one or more computing platforms 102 may include a user device such as a laptop computer. By way of non-limiting example, a given remote platform 104 and/or a given computing platform 102 may include one or more of a server, a desktop computer, a laptop computer, a handheld computer, a tablet computing platform, a smartphone, a gaming console, and/or other computing platforms. In some implementations, one or more computing platforms 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which one or more computing platforms 102, remote platform(s) 104, and/or external resources 120 may be operatively linked via some other communication media.

A given remote platform 104 and/or a given computing platform 102 may include one or more processors configured to execute computer program modules. The computer program modules may be configured to enable a user associated with the given remote platform 104 and/or a given computing platform 102 to interface with system 100 and/or external resources 120, and/or provide other functionality attributed herein to various embodiments.

External resources 120 may include sources of information outside of system 100, external entities participating with system 100, and/or other resources. In some implementations, some or all of the functionality attributed herein to external resources 120 may be provided by resources included in system 100.

One or more computing platforms 102 may include electronic storage 122, one or more processors 124, and/or other components. One or more computing platforms 102 may include communication lines, or ports to enable the exchange of information with a network and/or other computing platforms. The illustration of one or more computing platforms 102 in FIG. 1 is not intended to be limiting. One or more computing platforms 102 may include a plurality of hardware, software, and/or firmware components operating together to provide the functionality attributed herein to one or more computing platforms 102. For example, one or more computing platforms 102 may be implemented by a cloud of computing platforms operating together as one or more computing platforms 102.

Electronic storage 122 may comprise non-transitory storage media that electronically stores information. The electronic storage media of electronic storage 122 may include one or both of system storage that is provided integrally (i.e., substantially non-removable) with one or more computing platforms 102 and/or removable storage that is removably connectable to one or more computing platforms 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from one or more computing platforms 102, information received from remote platform(s) 104, and/or other information that enables one or more computing platforms 102 to function as described herein.

Processor(s) 124 may be configured to provide information processing capabilities in one or more computing platforms 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination.

It should be noted that various functions described herein may be implemented using processor executable instructions stored on a non-transitory storage medium or device, e.g., electronic storage 122. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting, and that various other changes and modifications may be affected therein by one skilled in the art without departing from the scope or spirit of the disclosure.

What is claimed is:

1. A method, comprising:
receiving a real-world two-dimensional (2D) image of a scene;
obtaining, using a set of one or more processors, a depth map for the real-world 2D image, the depth map being selectively corrected using a second depth map formed using a three-dimensional (3-D) model of the scene; and
creating, using the set of one or more processors, a representation of the scene based on the depth map selectively corrected by the 3-D model.

2. The method of claim 1, wherein the second depth map is generated using a second 2D image generated using a virtual camera pose and view of the 3-D model from the virtual camera pose.

3. The method of claim 1, wherein the second depth map is generated from a virtual camera pose relative to a 3-D model generated from a light detection and ranging (LiDAR) scan.

4. The method of claim 1, wherein the 2D image comprises different regions identified using a segmentation process.

5. The method of claim 4, comprising labeling one or more of the different regions with one or more semantic labels.

6. The method of claim 5, wherein the one or more different regions comprise one or more of a floor, a wall, and a ceiling.

7. The method of claim 5, comprising matching the one or more of the different regions with corresponding regions of the 3-D model.

8. The method of claim 7, wherein one or more depth values of the corresponding regions in the 3-D model are used to selectively correct one or more depth values of the depth map.

9. The method of claim 8, wherein the one or more selectively corrected depth values of the depth map belong to a non-corresponding region of the 2D image.

10. The method of claim 8, wherein the selectively corrected depth map comprises one or more depth values of the depth map corrected based on a position of the depth value in the 2D image relative to a position of a corresponding region in the second depth map.

11. The method of claim 10, wherein the position of the corresponding region in the second depth map is proximate to the depth value in the 2D image.

12. The method of claim 1, wherein the depth map is selectively corrected via one or more of replacing and modifying depth information of pixels of the real-world 2D image using depth information of the second depth map.

13. The method of claim 1, wherein the obtaining comprises requesting the depth map for the real-world 2D image from a model trained to generate depth maps, wherein the model is trained using a plurality of depth maps corrected by associated three-dimensional (3-D) models.

14. The method of claim 1, wherein the representation of the scene comprises 3D virtual imagery formatted for one or more of augmented reality (AR) and virtual reality (VR) display.

15. A system, comprising:
one or more processors; and
a non-transitory computer readable storage medium having one or more programs executable by the one or more processors and configurable for:
receiving a real-world two-dimensional (2D) image of a scene;
obtaining a depth map for the real-world 2D image, the depth map being selectively corrected using a second depth map formed using a three-dimensional (3-D) model of the scene; and
creating a representation of the scene based on the depth map selectively corrected by the 3-D model.

16. The system of claim 15, wherein the second depth map is generated using a second 2D image generated using a virtual camera pose and view of the 3-D model from the virtual camera pose.

17. The system of claim 15, wherein the 2D image comprises one or more different regions identified using a segmentation process.

18. The system of claim 17, wherein the one or more different regions comprise one or more of a floor, a wall, and a ceiling.

19. The system of claim 18, wherein the one or more programs are configurable for matching the one or more different regions with one or more corresponding regions of the 3-D model.

20. The system of claim 19, wherein one or more depth values of the one or more corresponding regions of the 3-D model are used to selectively correct one or more depth values of the depth map.

21. A computer program product, comprising:
a non-transitory computer readable storage medium having one or more programs executable by one or more processors and configurable for:
receiving a real-world two-dimensional (2D) image of a scene;
obtaining a depth map for the real-world 2D image, the depth map being selectively corrected using a second depth map formed using a three-dimensional (3-D) model of the scene; and
creating a representation of the scene based on the depth map selectively corrected by the 3-D model.
